(19) United States
(12) Patent Application Publication
(10) Pub. No.: US 2010/0160196 A1
(43) Pub. Date: Jun. 24, 2010

(54) Power Transmission Fluids with Improved Viscometric Properties

(76) Inventors: Dean B. Clarke, Neshanic Station, NJ (US); Carl Waterson, Didcot (GB); Ricardo A. Bloch, Scotch Plains, NJ (US); David J. Martella, Princeton, NJ (US)

Correspondence Address: INFINEUM USA L.P., P.O. BOX 710, LINDEN, NJ, 07036, US

(21) Appl. No.: 12/342,666

(22) Filed: Dec. 23, 2008

(51) Int. Cl. C10M 137/10; C08F 22/16; C08F 22/10; C08F 226/06; C08F 12/26; C10M 145/16

(52) U.S. Cl. 508/370; 526/321; 526/329.7; 526/328; 526/324; 526/265; 526/263; 526/310; 508/466

(57) ABSTRACT

A copolymer which can be used in power transmission fluids to provide improved viscometric properties is disclosed. The copolymer includes a mixture of alcohols having side chains with an average number of carbons ranging from greater than 8 to less than 12 defined by the following formula:

$${C}_{n} = \frac{{\sum }_{i = j}^{i = z} {X}_{i} {Cn}_{i}}{{\sum }_{i = j}^{i = z} {X}_{i}}$$

where Xᵢ is the mole fraction of alcohol (i); Cₙᵢ represents the number of carbon atoms in alcohol (i); j is the lowest number of carbons in an alcohol in the copolymer and must be at least 6; and z is the highest number of carbons in an alcohol.

### FIELD OF THE INVENTION

The present invention relates to novel copolymers which can be used in power transmission fluids to provide improved viscometric properties.

### BACKGROUND OF THE INVENTION

Various vehicular power transmission systems such as automatic transmissions, manual transmissions, continuously variable transmissions, etc. are well known in the art. New power transmission systems are constantly being designed and conventional power transmission systems are continuously being re-designed to provide improved vehicle operability, reliability, and fuel economy.

Typically, a new or re-designed power transmission system requires a specially formulated power transmission fluid in order to meet its performance specifications. The fluids must meet standards set by the vehicle manufacturers. For example, General Motors introduced a Dexron-VI specification for automatic transmission fluids in 2006 model year cars and trucks equipped with Hydra-Matic transmissions. The Dexron-VI specification ratchets up performance demands to accommodate transmission design changes as well as pushes by automakers for fluids to last longer and perform better. The Dexron-VI specification requires power transmission fluids to exhibit a fluid viscosity at −40° C. of less than or equal to 15,000 centipoise (cP).

In order to provide power transmission fluids that are capable of exhibiting the requisite performance requirements, one or more of the following additive components must be mixed in specific proportions with a base oil: viscosity modifiers, lube oil flow improvers (“LOFIs”), friction modifiers, dispersants, metallic detergents, antiwear agents, viscosity modifiers (VM), etc. Generally speaking, these types of components are well known in the art, but the specific chemical compositions of the various components are continually being invented.

The present invention provides a novel copolymer possessing characteristics of both a LOFI and a VM which can be used in power transmission fluids to provide improved viscometric properties. The copolymer comprises a mixture of alcohols having an average number of carbon atoms in their side chains ranging from greater than 8 to less than 12 calculated using a specific equation. The copolymer can exhibit a thickening efficiency (“TE”) ranging from 0.10 to 1.00.

### SUMMARY OF THE INVENTION

In a non-limiting embodiment, the present invention is a copolymer for power transmission fluids comprising a mixture of alcohols having side chains with an average number of carbons (Cₙ) ranging from greater than 8 to less than 12 defined by the following formula:

$${C}_{n} = \frac{{\sum }_{i = j}^{i = z} {X}_{i} {Cn}_{i}}{{\sum }_{i = j}^{i = z} {X}_{i}}$$

where Xᵢ is the mole fraction of alcohol (i); Cₙᵢ represents the number of carbon atoms in alcohol (i); j is the lowest number of carbons in an alcohol in the copolymer and must be at least 6; and z is the highest number of carbons in an alcohol.

In another non-limiting embodiment, the present invention is a power transmission fluid composition comprising: (a) base oil comprising a Group II base stock, a Group III base stock and/or a Group IV base stock as well as mixtures thereof; and (b) a copolymer comprising a mixture of alcohols having side chains with an average number of carbons (Cₙ) ranging from greater than 8 to less than 12 defined by the following formula:

$${C}_{n} = \frac{{\sum }_{i = j}^{i = z} {X}_{i} {Cn}_{i}}{{\sum }_{i = j}^{i = z} {X}_{i}}$$

where Xᵢ is the mole fraction of alcohol (i); Cₙᵢ represents the number of carbon atoms in alcohol (i); j is the lowest number of carbons in an alcohol in the copolymer and must be at least 6; and z is the highest number of carbons in an alcohol.

### DETAILED DESCRIPTION OF THE INVENTION

Unless otherwise indicated, all numbers expressing quantities of ingredients, reaction conditions, dimensions, physical characteristics, processing parameters, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 5.5 to 10. Any mentioning of a U.S. Patent or patent document or literature reference in the following description also incorporates by reference that document herein and is to be understood to be incorporated in its entirety.

Various terms are used throughout this specification. Definitions for some of these terms are provided below.

The term “base stock” is defined in accordance with the definition provided in the American Petroleum Institute (API) publication “Engine Oil Licensing and Certification System”, Industry Services Department, Fourteenth Edition, December 1996, Addendum 1, December 1998. A base stock is classified as Group I, Group II, Group III, Group IV or Group V depending on the criteria specified below measured using the specified test.

A Group I base stock contains less than 90 percent saturates and/or greater than 0.03 percent sulfur and has a viscosity index greater than or equal to 80 and less than 120.

A Group II base stock contains greater than or equal to 90 percent saturates and less than or equal to 0.03 percent sulfur and has a viscosity index greater than or equal to 80 and less than 120.

A Group III base stock contains greater than or equal to 90 percent saturates and less than or equal to 0.03 percent sulfur and has a viscosity index greater than or equal to 120

A Group IV base stock is a polyalphaolefin (PAO) which is a synthetic base stock.

A Group V base stock encompasses all other base stocks which cannot be classified as a Group I, II, III, or IV base stock.

The term “Thickening Efficiency” (TE) describes a polymer's ability to thicken oil per unit mass and is defined as:

$$T E = \frac{2}{c ln 2} ln ( \frac{{kv}_{oil + polymer}}{{kv}_{oil}} )$$

wherein c is polymer concentration (grams of polymer/100 grams solution), kv_{oil+polymer} is kinematic viscosity of the polymer in the reference oil, and kvₒᵢₗ is kinematic viscosity of the reference oil.

The term “molecular weight” (M_{w}) refers to the weight average molecular weight. The M_{w} values herein were determined using gel permeation chromatography based on polystyrene calibration.

The present invention is a novel copolymer for lubricant compositions. The copolymer comprises a mixture of alcohols having side chains with an average number of carbon atoms (Cₙ) ranging from greater than 8 to less than 12 defined by the following formula:

$${C}_{n} = \frac{{\sum }_{i = j}^{i = z} {X}_{i} {Cn}_{i}}{{\sum }_{i = j}^{i = z} {X}_{i}}$$

where Xᵢ is the mole fraction of alcohol (i); Cₙᵢ represents the number of carbon atoms in alcohol (i); j is the lowest number of carbons in an alcohol in the copolymer and must be at least 6; and z is the highest number of carbons in an alcohol.

The following provides an example of how Cₙ is calculated. Assume we have a copolymer comprising a mixture of the following alcohols: 0.2 mole fraction of an alcohol with a four (4) carbon side chain; 0.2 mole fraction of an alcohol with an eight (8) carbon side chain; 0.3 mole fraction of an alcohol with a ten (10) carbon side chain; and 0.3 mole fraction of an alcohol with a twelve (12) carbon side chain. The copolymer has a mixture of alcohols whereby the average number of carbon atoms of the alcohol side chains equals (0.2*8+0.3*10+0.3*12)/(0.2+0.3+0.3)=10.25. Notice the alcohol having less than six carbon atoms in its side chain, like the 0.2 mole fraction of an alcohol with a four (4) carbon side chain, was not included in the calculation.

The average number of carbon atoms in the side chains for the various alcohols that make up the copolymer is important because it determines the crystallization temperature of the copolymer. The crystallization temperature of the copolymer affects how the copolymer interacts with wax in the lubricant composition.

The copolymer of the present invention can comprise various monomers. In a non-limiting embodiment of the present invention, the copolymer comprises a first monomer ester of an unsaturated dicarboxylic acid with an alkyl group having from about C₆ to about C₂₄ carbon atoms, wherein the average number of carbon atoms in the side chains of the alcohols ranges from greater than 8 to less than 12.

In another non-limiting embodiment of the invention, the copolymer comprises a fumarate-vinyl acetate (“FVA”) copolymer. The FVA copolymer can be prepared from dicarboxylic acid esters as is well known in the art. Other suitable dicarboxylic acid esters can be represented by the general formulas:

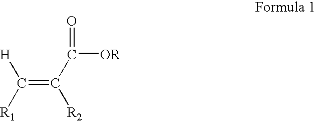

wherein R is a C₆ to C₁₈ straight chain alkyl group, R₁ is selected from the group consisting of hydrogen and COOR, and R₂ is hydrogen or a C₁ to C₄ alkyl group, e.g., methyl.

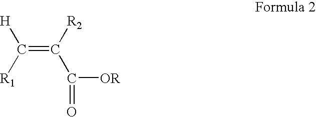

wherein R is a C₆ to C₁₈ straight chain alkyl group, R₁ is selected from the group consisting of hydrogen and COOR, and R₂ is hydrogen or a C₁ to C₄ alkyl group, e.g., methyl.

Examples of the abovementioned dicarboxylic acid esters include fumarate and maleate esters such as didecyl fumarate, decyl-lauryl fumarate, dilauryl fumarate, lauryl-hexadecyl fumarate, lauryl maleate, etc.

In this embodiment of the invention, the FVA polymer can contain from 40 to 60 mole percent of fumarate and from 60 to 40 mole percent of vinyl acetate. The dialkyl fumarate can have from 50 to 100 wt. % of its alkyl groups ranging from C₆ to C₂₄.

In yet another non-limiting embodiment of the invention, the copolymer comprises maleate vinyl acetate (“MVA”) copolymer. In another embodiment of the invention, the copolymer comprises a combination of FVA copolymer and MVA copolymer.

The copolymer of the present invention can be formed by various methods which are well known in the art. In a non-limiting embodiment of the invention, the copolymer is formed by free-radical polymerization of a dicarboxylic ester containing 0.5 mole fraction of an alcohol having ten (10) carbon atoms and 0.5 mole fraction of an alcohol having twelve (12) carbon atoms.

In another non-limiting embodiment of the invention, the copolymer is formed by polymerizing dialkyl fumarate (DAF) and vinyl acetate (VA) as is well known in the art.

In a non-limiting embodiment of the invention, the copolymer exhibits a thickening efficiency (“TE”) ranging from 0.10 to 1.00.

The descriptions of the copolymer of the invention above encompass various “spacer” monomers added to the backbone of the copolymer for the purpose of extending the chain length per mass and increasing the thickening efficiency of the copolymer. Suitable spacer monomers include, but are not limited to, maleic or fumaric esters having side chain alcohols with less than six (6) carbons or alpha olefins with less than eight (8) carbon atoms (e.g., 1-octene with two carbon atoms in the backbone).

In a non-limiting embodiment of the invention, the spacer monomer is an olefin defined by the following formula:

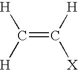

where X is hydrogen; a linear or branched alkyl group, e.g., methyl, ethyl, 1-propyl, 2-propyl, 1-butyl, 2-butyl, 1-pentyl, 1-hexyl; a halogen, e.g., chloride, bromide; or an alkyl ether, e.g., methoxyl, ethoxyl.

In various non-limiting embodiments of the invention, other polymers can be mixed with the copolymer of the invention to provide improved thickening efficiency. For example, an olefin copolymer can be mixed with the copolymer of the invention. As another example, a polyisoprene-containing polymer can be mixed with the copolymer of the invention.

In certain instances, it may be beneficial to modify the copolymer of the invention so it has dispersant like properties (i.e., the copolymer has polarity to function as a dispersant). Thus, in a non-limiting embodiment of the invention, the copolymer contains nitrogen species such as N-vinylimidazole, N-phenyl-1-phenylenediamine, vinyl pyridine, etc.

The copolymer of the present invention containing nitrogen species can be formed by various methods which are well known in the art. For example, the copolymer of the invention can be copolymerized with a nitrogen containing monomer such as, but not limited to, an amide formed by reacting methacrylic acid and dimethylaminopropylamine. As another example, the copolymer of the present invention can be grafted with a nitrogen-containing grafting agent such as, but not limited to, N-vinylimidazole.

The present invention also encompasses a power transmission fluid comprising (a) a base oil and (b) at least one copolymer as described above.

According to the present invention, the base oil comprises one or more base stocks. Suitable base oil comprises a Group I base stock, a Group II base stock, a Group III base stock and/or a Group IV base stock as well as mixtures thereof.

In a non-limiting embodiment of the invention, the base oil comprises up to 5% of a Group I base stock.

In another non-limiting embodiment of the invention, the base oil comprises a Group II base stock. An example of a suitable Group II base stock is Yubase 3 which is commercially available from Yukong Limited Corporation (South Korea).

In another non-limiting embodiment of the invention, the base oil comprises a Group III base stock. Examples of suitable Group III base stocks are Yubase 4 and Yubase 6 which are commercially available from Yukong Limited Corporation (South Korea).

In a non-limiting embodiment of the invention, the base oil has a viscosity of less than 4.7 centistokes, for example from 3.5 to 4.7 centistokes. In another non-limiting embodiment of the invention, the base oil has a NOACK value ranging from 15 to 35 percent. NOACK values indicate the volatility of an oil and are determined according to ASTM D 5800.

According to the present invention, the power transmission fluid can comprise one or more of the following components which are well known in the art: metallic detergents, viscosity modifiers, oxidation inhibitors, friction modifiers, antifoamants, antiwear agents, etc.

In a non-limiting embodiment of the invention, the power transmission fluid comprises one or more friction modifiers. Suitable friction modifiers include, but are not limited to, glyceryl monoesters of higher fatty acids, for example, glyceryl mono-oleate; esters of long chain polycarboxylic acids with diols, for example, the butane diol ester of a dimerized unsaturated fatty acid; oxazoline compounds; and alkoxylated alkyl-substituted mono-amines, diamines and alkyl ether amines, for example, ethoxylated tallow amine and ethoxylated tallow ether amine. Suitable friction modifiers are described in more detail in U.S. Pat. No. 7,300,910 which is hereby incorporated by reference.

In a non-limiting embodiment of the invention, the power transmission fluid comprises one or more metallic detergents. Suitable metallic detergents include oil-soluble neutral and overbased sulfonates, phenates, sulfurized phenates, thiophosphonates, salicylates, and naphthenates and other oil-soluble carboxylates of a metal. Suitable metallic detergents are described in more detail in U.S. Pat. No. 7,300,910 which is hereby incorporated by reference.

In a non-limiting embodiment of the invention, the power transmission fluid includes antiwear agents such as dihydrocarbyl dithiophosphate metal salts. The metal can be an alkali or alkaline earth metal, or aluminum, lead, tin, molybdenum, manganese, nickel or copper. Suitable antiwear agents are described in more detail in U.S. Pat. No. 7,300,910 which is hereby incorporated by reference.

In a non-limiting embodiment of the invention, the power transmission fluid comprises oxidation inhibitors. Examples of suitable oxidation inhibitors include, but are not limited to, hindered phenols, alkaline earth metal salts of alkylphenolthioesters, calcium nonylphenol sulfide, oil soluble phenates and sulfurized phenates, phosphosulfurized or sulfurized hydrocarbons, phosphorous esters, metal thiocarbamates, oil soluble copper compounds and molybdenum-containing compounds. Suitable oxidation inhibitors are described in more detail in U.S. Pat. No. 7,300,910 which is hereby incorporated by reference.

In a non-limiting embodiment of the invention, the power transmission fluid comprises one or more viscosity modifiers. Examples of suitable viscosity modifiers include polyisobutylene, copolymers of ethylene and propylene, polymethacrylates, methacrylate copolymers, copolymers of an unsaturated dicarboxylic acid and a vinyl compound, interpolymers of styrene and acrylic esters, and partially hydrogenated copolymers of styrene/isoprene, styrene/butadiene, and isoprene(butadiene, as well as the partially hydrogenated homopolymers of butadiene and isoprene.

In a non-limiting embodiment of the invention, the power transmission fluid comprises one or more antifoamants. Suitable antifoamants include, but are not limited to, polysiloxanes such as silicone oil or polydimethyl siloxane.

Lubricant compositions such as power transmission fluids according to the present invention exhibit improved (i.e., lower viscosities at lower temperatures) viscometric properties. For example, lubricant compositions according to the present invention can satisfy the requirement of a Brookfield viscosity at −40° C. of less than or equal to 20,000 cP, or of less than or equal to 15,000 cP.

### EXAMPLES

The present invention is illustrated by the following, non-limiting examples. The copolymer of the present invention was formed in the following manner. First, a C₁₀-C₁₂ fumarate monomer was synthesized. The reactants shown in Table 1 were combined in a 2 liter RB flask assembled for Dean and Stark esterification. The reactants were heated with stirring to 130° C. for 9 hours.

The flask was allowed to cool and the solution was washed with two (2), 500 mL portions of 5% NaOH (aq) solution followed by a washing with three (3) 500 mL portions of distilled water. A toluene layer formed. The toluene layer was dried with anhydrous MgSO₄, filtered and rotary evaporated at 100° C./0 mbar for 90 minutes. The steps described above yielded 821.20 g of fumarate monomer.

TABLE 1
Reactants for the Synthesis of the C₁₀-C₁₂ Fumarate Monomer

| Component | Amount [g] |
|---|---|
| Analar Toluene¹ | 500 |
| Decyl Alcohol² | 316.56 |
| Dodecyl Alcohol² | 372.68 |
| Fumaric Acid² | 232.14 |
| p-Toluene Sulphonic Acid² | 23.1 |

¹Analar Toluene is commercially available from BDH Chemicals Ltd. (Poole, England).
²Decyl Alcohol, Dodecyl Alcohol, Fumaric Acid and p-Toluene Sulphonic Acid are all commercially available from Sigma- Aldrich Co. (St. Louis, MO).

Next, a C₁₀-C₁₂ fumarate-vinyl acetate copolymer was synthesized from the monomer. The fumarate monomer prepared above was charged into an autoclave reactor. The contents of the reactor were heated to 60° C. to melt the fumarate monomer, and the reactor was then purged with nitrogen to remove oxygen. Next, 22.85 g of degassed vinyl acetate and 32.05 g of cyclohexane were added to the reactor. The autoclave was sealed, heated to 117° C., and the pressure was adjusted to 4.2 bar using nitrogen.

After the reactor was allowed to stabilize, an initiator solution comprising 5.78 weight percent of t-butyl peroxy perpivalate in cyclohexane was added to the autoclave using a standard high performance liquid chromatograph pump at a constant rate over 110 minute period. The contents in the reactor were allowed to sit for 15 minutes and then emptied into a 500 mL, round bottom flask. The resulting solution was stripped on a rotary evaporator for 90 minutes at 100° C. at 20 mbar vacuum. The steps above yielded 146.33 g of copolymer.

Several analytical tests were performed on the copolymer. The specific viscosity of the copolymer was measured at 2 weight percent per volume percent in toluene at 40° C. The measured specific viscosity was 0.23. The Mw of the copolymer was measured using Gel Permeation Chromatography (GPC). The measured Mw was about 30,000 Daltons.

In order to measure the performance properties of a power transmission according to the present invention, the copolymer was blended into DEXRON VI-type power transmission fluids using techniques which are well known in the art. The “adpack” in the fluid contains conventional amounts of succinimide dispersant, antioxidants, antiwear agents, friction modifiers, corrosion inhibitor, antifoamant and diluent oil. The compositions of Examples 1-5 are shown in Table 2.

TABLE 2
Compositions of Power Transmission Fluids formulated with the
Copolymer of the Invention

| | Ex. 1 | Ex. 2 | Ex. 3 | Ex. 4 | Ex. 5 |
|---|---|---|---|---|---|
| Components | [mass %] | [mass %] | [mass %] | [mass %] | [mass %] |
| Avg. number of carbons atoms in the side | 8 | 11 | 11 | 11 | 12 |
| chains of the alcohols in the copolymer | | | | | |
| Adpack | 8.000 | 8.000 | 8.000 | 8.000 | 8.000 |
| Yubase 6 | 49.468 | 49.022 | 49.709 | 49.709 | 49.201 |
| Yubase 3 | 40.542 | 40.177 | 40.739 | 40.739 | 40.325 |
| C10-C12 FVA | 0.000 | 2.551 | 0.000 | 0.000 | 0.000 |
| C11 FVA with 40% of the FVA replaced | 0.000 | 0.000 | 1.052 | 1.052 | 0.000 |
| with maleate | | | | | |
| C8 FVA | 1.740 | 0.000 | 0.000 | 0.000 | 0.000 |
| C12 FVA | 0.000 | 0.000 | 0.000 | 0.000 | 2.224 |
| Infineum V385* | 0.250 | 0.250 | 0.500 | 0.000 | 0.250 |
| Viscoplex 1-300* | 0.000 | 0.000 | 0.000 | 0.500 | 0.000 |

*Infineum V385 and Viscoplex 1-300 are both commercially available pour point depressants from RohMax Oil Additives.

Various performance properties of the power transmission fluids of Examples 1-5 were measured. KV100 and KV40 were measured according to ASTM D 445. The viscosity index was measured according to ASTM D 2270. The Brookfield Viscosity at −40° C. was measured according to ASTM D 2983.

The performance properties of the exemplary power transmission fluids are summarized in Table 3 below.

TABLE 3
Performance Properties of the Exemplary Power Transmission Fluids

| Performance Property | Ex. 1 | Ex. 2 | Ex. 3 | Ex. 4 | Ex. 5 |
|---|---|---|---|---|---|
| TE in Yubase | 0.186 | 0.144 | 0.430 | 0.430 | 0.186 |
| Kv100 (cSt) | 6.1 | 5.9 | 6.1 | 6.2 | 5.9 |
| Kv40 (cSt) | 30.6 | 29.8 | 29.4 | 30.0 | 29.7 |
| Viscosity Index | 150 | 147 | 158 | 161 | 148 |
| Brookfield Viscosity | 33,600 | 13,900 | 16,600 | 12,700 | 88,200 |
| at −40 C. (cP) | | | | | |
| NOACK (mass %) | 22.2 | 22.2 | 22.2 | 22.2 | 22.2 |

### CONCLUSIONS

Examples 2, 3 and 4 are illustrative of power transmission fluids according to the present invention. Examples 2 and 4 contain a copolymer comprising alcohols having an average of eleven (11) carbon atoms. Example 3 also contains a copolymer comprising alcohols having an average of eleven (11) carbon atoms and contains a dimethyl maleate spacer. Examples 2, 3 and 4 all exhibit a Brookfield Viscosity at −40° C. less than 20,000 cP.

Examples 1 and 5 are illustrative of power transmission fluids which fall outside the present invention. Example 1 contains a copolymer comprising alcohols having an average of eight (8) carbon atoms in its side chains. Example 5 contains a copolymer comprising alcohols having an average of twelve (12) carbon atoms in its side chains. Examples 1 and 5 exhibit a Brookfield Viscosity at −40° C. greater than 30,000 cP.

What is claimed is:

1. A copolymer for improving the viscosity performance of power transmission fluids comprising: a mixture of alcohols having side chains with an average number of carbons ranging from greater than 8 to less than 12 defined by the following formula:
$${C}_{n} = \frac{{\sum }_{i = j}^{i = z} {X}_{i} {Cn}_{i}}{{\sum }_{i = j}^{i = z} {X}_{i}}$$
where Xᵢ is the mole fraction of alcohol (i); Cₙᵢ represents the number of carbon atoms in alcohol (i); j is the lowest number of carbons in an alcohol in the copolymer and must be at least 6; and z is the highest number of carbons in an alcohol.

2. The copolymer according to claim 1 comprising a first monomer ester of an unsaturated dicarboxylic acid with an alkyl group having from about C₆ to about C₂₄ carbon atoms.

3. The copolymer according to claim 1 wherein the copolymer comprises an FVA copolymer.

4. The copolymer according to claim 3 wherein the FVA copolymer is prepared from a dicarboxylic ester.

5. The copolymer according to claim 3 wherein the FVA copolymer is 40 to 60 mole percent dialkyl fumarate and 60 to 40 mole percent vinyl acetate.

6. The copolymer according to claim 1 comprising a polymethacrylate, polyacrylate or styrene-maleate copolymer.

7. The copolymer according to claim 1 wherein the copolymer includes a spacer monomer selected from the group consisting of dimethyl maleate, 1-hexene and diethyl maleate.

8. The copolymer according to claim 3 comprising FVA polymer and an olefin spacer monomer.

9. The copolymer according to claim 3 comprising FVA polymer and a polyisoprene-containing spacer monomer.

10. The copolymer according to claim 3 wherein the FVA polymer contains a nitrogen species.

11. The copolymer according to claim 10 wherein the nitrogen species is selected from the group consisting of vinyl pyridine, N-vinylimidazole and N-phenyl-1-phenylenediamine.

12. The copolymer according to claim 1 wherein the copolymer exhibits a thickening efficiency (“TE”) ranging from 0.10 to 1.00.

13. A power transmission fluid composition comprising:
(a) base oil comprising a Group II base stock, a Group III base stock and/or a Group IV base stock as well as mixtures thereof; and
(b) copolymer having side chains with an average number of carbons ranging from greater than 8 to less than 12 defined by the following formula:
$${C}_{n} = \frac{{\sum }_{i = j}^{i = z} {X}_{i} {Cn}_{i}}{{\sum }_{i = j}^{i = z} {X}_{i}}$$
where Xᵢ is the mole fraction of alcohol (i); Cₙᵢ represents the number of carbon atoms in alcohol (i); j is the lowest number of carbons in an alcohol in the copolymer and must be at least 6; and z is the highest number of carbons in an alcohol.

14. The power transmission fluid according to claim 13 wherein the base oil comprises up to 5% of a Group I base stock.

15. The power transmission fluid according to claim 13 wherein the base oil comprises a Group II base stock.

16. The power transmission fluid according to claim 13 wherein the base oil comprises a Group III base stock.

17. The power transmission fluid according to claim 13 wherein the base stock has a viscosity of less than 4.7.

18. A power transmission fluid according to claim 13 comprising one or more of the following components which are well known in the art: detergents, metal rust inhibitors, viscosity index improvers, corrosion inhibitors, oxidation inhibitors, friction modifiers, dispersants, anti-foaming agents and anti-wear agents.

19. The power transmission fluid according to claim 13 wherein the antiwear agent is a dihydrocarbyl dithiophosphate metal salt.

20. The power transmission fluid according to claim 13 wherein the fluid exhibits a Brookfield viscosity at −40° C. less than or equal to 20,000 cP.
